(19) United States
(12) Patent Application Publication
(10) Pub. No.: US 2010/0074997 A1
(43) Pub. Date: Mar. 25, 2010

(54) Starch Based Fat-Replacer by Crystallization of Enzyme Modified Starch and High-Pressure Shearing

(76) Inventors: Annette Evans, Decatur, IL (US); Patricia Richmond, Mount Zion, IL (US); Thomas Eilers, Saraland, AL (US); David Durkee, Mount Zion, IL (US)

Correspondence Address: WILLIAMS, MORGAN & AMERSON, P.C., 10333 RICHMOND, SUITE 1100, HOUSTON, TX, 77042, US

(21) Appl. No.: 12/555,847

(22) Filed: Sep. 9, 2009

Related U.S. Application Data
(60) Provisional application No. 61/098,339, filed on Sep. 19, 2008.

(51) Int. Cl. A23L 1/0522; A23L 1/24; A23L 1/39

(52) U.S. Cl. 426/64; 426/589; 426/661

(57) ABSTRACT

We disclose a composition comprising greater than about 95% d.s.b. of a starch comprising short chain amylose having an average degree of polymerization (DP) from about 20 to about 150, wherein an aqueous slurry comprising about 20% d.s.b. of the composition has a minimum yield stress of at least 400 Pa. We also disclose a method of preparing the composition comprising contacting a starch paste with a 4-α-glucanotransferase, to yield a chain-extended starch; contacting the chain-extended starch with a debranching enzyme, to yield a debranched starch; crystallizing the debranched starch, to yield a crystallized debranched starch; and shearing the crystallized debranched starch, to yield the composition. We also disclose a food formulation comprising a foodstuff and the composition.

This application claims priority from U.S. provisional patent application Ser. No. 61/098,339, filed on Sep. 19, 2008, which is incorporated herein by reference.

This invention relates to food ingredients. Specifically, it relates to compositions comprising starch that are useful as fat replacers.

### BACKGROUND OF THE INVENTION

For reasons of both improved health and more attractive appearance, a great interest exists in reducing the intake of fats in the typical diet in the developed world. However, reducing fat intake by reducing the intake of foods containing fat is undesirable, in light of the general observation that foods with a high fat content typically have a more pleasing taste than comparable foods with a low fat content.

Therefore, it would be desirable to have compositions, suitable for use as food ingredients, which could be used to replace fat in foods with a non-fat edible material having both a texture comparable to that of fat and physical properties that allow the composition to retain its texture during cooking or other processing, especially high-temperature processing.

### SUMMARY OF THE INVENTION

In one embodiment, the present invention relates to a composition comprising a starch comprising short chain amylose having an average degree of polymerization (DP) from about 20 to about 150, wherein an aqueous slurry comprising about 20% d.s.b. of the composition has a minimum yield stress of at least 400 Pa.

In another embodiment, the present invention relates to a method of preparing a composition comprising a starch comprising at least about 90 wt % comprising short chain amylose having an average degree of polymerization (DP) from about 20 to about 150, wherein an aqueous slurry comprising about 20% d.s.b. of the composition has a minimum yield stress of at least 400 Pa, the method comprising: contacting a starch paste with a 4-α-glucanotransferase, to yield a chain-extended starch; contacting the chain-extended starch with a debranching enzyme, to yield a debranched starch; crystallizing the debranched starch, to yield a crystallized debranched starch; and shearing the crystallized debranched starch, to yield the composition.

In one embodiment, the present invention relates to a food formulation comprising a foodstuff and a composition comprising a starch comprising short chain amylose having an average degree of polymerization (DP) from about 20 to about 150, wherein an aqueous slurry comprising about 20% d.s.b. of the composition has a minimum yield stress of at least 400 Pa.

The composition has a texture comparable to fat and has a melting point greater than about 90° C., the combination of which properties renders it suitable for use as a fat replacer in foods. Also, a spray-dried composition as prepared according to one embodiment of the method can be readily reconstituted in water with stirring or mild blending, which renders it further suitable for use as a fat replacer in foods.

### BRIEF DESCRIPTION OF THE DRAWINGS

FIG. 1 shows the yield stress versus strain of several samples discussed in Example 3.

FIG. 2 shows the strain sweep of several samples discussed in Example 4.

### DESCRIPTION OF ILLUSTRATIVE EMBODIMENTS

In one embodiment, the present invention relates to a composition comprising a starch comprising short chain amylose having an average degree of polymerization (DP) from about 20 to about 150, wherein an aqueous slurry comprising about 20% d.s.b. of the composition has a minimum yield stress of at least 400 Pa.

In one embodiment, the starch comprises at least about 90% short chain amylose.

The starch can come from a variety of sources known in the art. In one embodiment, the starch is from dent corn, waxy corn, high amylose corn, potato, tapioca, rice, pea, wheat, waxy wheat, or a combination of two or more of these starch sources. Chemically modified starches, such as hydroxypropyl starches, starch adipates, acetylated starches, and phosphorylated starches, can also be used in the present invention. For example, suitable chemically modified starches include, but are not limited to, crosslinked starches, acetylated and organically esterified starches, hydroxyethylated and hydroxypropylated starches, phosphorylated and inorganically esterified starches, cationic, anionic, nonionic, and zwitterionic starches, and succinate and substituted succinate derivatives of starch. Such modifications are known in the art, for example in Modified Starches: Properties and Uses, Ed. Wurzburg, CRC Press, Inc., Florida (1986). Other suitable modifications and methods are disclosed in U.S. Pat. Nos. 4,626,288, 2,613,206 and 2,661,349, which are incorporated herein by reference.

In one embodiment, the starch is dent corn starch.

The composition may be prepared by any process. In one embodiment, the composition is prepared by a process comprising contacting a starch paste with a 4-α-glucanotransferase, to yield a chain-extended starch; contacting the chain-extended starch with a debranching enzyme, to yield a debranched starch; crystallizing the debranched starch, to yield a crystallized debranched starch; and shearing the crystallized debranched starch, to yield the composition. This process will be described in more detail below.

In addition to the starch, the composition may further comprise other materials. In one embodiment, the composition further comprises from about 0.5% d.s.b. to about 2% d.s.b. of a thickening agent. In one further embodiment, the thickening agent is xanthan gum.

In an embodiment wherein the composition further comprises xanthan gum, the composition may be prepared by a process as discussed above, further comprising combining the crystallized debranched starch with xanthan gum, to yield a mixture comprising starch and xanthan gum; and wherein shearing comprises shearing the mixture comprising starch and xanthan gum.

The composition may further comprise a surfactant. In one embodiment, the surfactant is a compound and in an amount generally considered suitable for use in a food additive or in the preparation of a food additive; for example, the surfactant may be Generally Recognized as Safe (GRAS) at the amount intended for inclusion in the composition under designation of the U.S. Food and Drug Administration or a comparable government agency in western or central Europe, Japan, Canada, Australia, New Zealand, or a similar developed country. In one embodiment, the surfactant is sodium dodecyl sulfate (SDS), present in the composition in an amount from about 0.5% d.s.b. to about 4% d.s.b.

The composition may further comprise a sweetener, such as sucrose, high fructose corn syrup (HFCS), fructose, dextrose, regular corn syrup, or corn syrup solids.

In one embodiment, the composition has a melting point greater than or equal to about 90° C.

The composition may be substantially solid, an aqueous slurry comprising starch, or any other formulation known in the art.

In one embodiment, the present invention relates to a method of preparing a composition comprising a starch comprising short chain amylose having an average degree of polymerization (DP) from about 20 to about 150, wherein an aqueous slurry comprising about 20% d.s.b. of the composition has a minimum yield stress of at least 400 Pa, the method comprising:

contacting a starch paste with a 4-α-glucanotransferase, to yield a chain-extended starch;

contacting the chain-extended starch with a debranching enzyme, to yield a debranched starch;

crystallizing the debranched starch, to yield a crystallized debranched starch; and

shearing the crystallized debranched starch, to yield the composition.

Regarding the first contacting step, 4-α-glucanotransferase [2.4.1.25] is an enzyme that catalyzes the transfer of a segment of a 1,4-α-D-glucan to a new position in an acceptor, which can be glucose or another 1,4-α-D-glucan. Glucanotransferase will catalyze the transfer of a maltosyl moiety to a maltotriose acceptor, releasing glucose. The glucose released can be used as a measurement of enzyme activity, if desired.

Treatment of the starch paste with glucanotransferase produces extensions of the chains on the amylopectin molecules. This treatment can be performed, for example, in aqueous solution or suspension at a temperature from about 70° C. to about 100° C. and a pH from about 5.0 to about 6.0.

In some embodiments of the invention, the dosage of glucanotransferase can be from about 2500 GTU/lb of starch to about 20,000 GTU/lb of starch. The glucanotransferase can be contacted with the starch in a single dose, or split into multiple doses. In some embodiments, the reaction temperature can be from about 85° C. to about 95° C., and the reaction time can be from about 1 hour to about 8 hours, such as from about 2 hours to about 4 hours.

Turning to the second contacting step, the chain-extended starch can be treated with debranching enzyme, such as isoamylase or pullulanase. Isoamylase treatment, can, for example, be performed at a temperature from about 40° C. to about 70° C. and a pH from about 3.5 to about 4.5. In certain embodiments of the invention, the dosage of debranching enzyme is from about 150,000 U/kg of starch to about 15,000,000 U/kg of starch.

Debranching enzyme treatment yields a debranched starch, which thereafter can be crystallized to yield a crystallized debranched starch.

Crystallization of the debranched starch can be performed by any appropriate technique. “Crystallization” is used herein to refer to crystallization of at least about 50 wt % of the debranched starch, such as crystallization of at least about 60 wt % of the debranched starch, crystallization of at least about 75 wt % of the debranched starch, crystallization of at least about 95 wt % of the debranched starch, crystallization of at least about 99.5 wt % of the debranched starch, or crystallization of at least about 99.9 wt % of the debranched starch. “Crystallization,” as used herein, does not require complete crystallization of the debranched starch.

In one embodiment, a slurry comprising the debranched starch resulting from debranching enzyme treatment can be cooked, such as in a jet cooker, at a temperature from about 120° C. to about 180° C. and thereafter cooled to a temperature from about 40° C. to about 70° C. The cooled cooked debranched starch can be held overnight, dewatered in a dryer, or both to promote crystallization. The crystallized debranched starch may further be ground or otherwise processed into particles having a desired size, such as a size small enough to pass through a US #40 mesh sieve.

The crystallized debranched starch can be sheared by any appropriate technique to yield the composition. In one embodiment, an aqueous slurry comprising about 10-40% d.s.b., such as 18-25% d.s.b., crystallized debranched starch is loaded in a microfluidizer and sheared one or more times at a pressure greater than about 1,000 psig, such as about 10,000 psig. Thereafter, the composition can be cooled to 4° C. and held at that temperature until ready for use. Depending on the desired use, it may be further spray dried.

The yield stress of the composition can be measured by any appropriate technique. In one embodiment, a Brookfield vein method is used to measure the yield stress. In one embodiment, the composition has a yield stress greater than about 400 Pa. In a further embodiment, the composition has a yield stress greater than about 800 Pa.

The strain-sweep behavior of the composition can be measured by any appropriate technique. In one embodiment, a TC rheometer is used to measure the strain-sweep. In one embodiment, the composition has a strain-sweep less than about 20.

Exemplary techniques for measuring the yield stress or strain-sweep of the composition are discussed in Examples 3-5.

The method described above can be modified if it is desired to include other materials in the composition. In one embodiment, the method further comprises combining the crystallized debranched starch with xanthan gum, to yield a mixture comprising starch and xanthan gum; and wherein shearing comprises shearing the mixture comprising starch and xanthan gum, to yield the composition. Combining can be performed as a routine matter for the person of ordinary skill in the art, and shearing can be performed essentially as described above. In one embodiment, combining comprises adding from about 0.5% d.s.b. to about 2% d.s.b. xanthan gum to an aqueous slurry comprising crystallized debranched starch.

Other additives, such as a surfactant, for example, SDS as described above, can be incorporated into the composition by similar steps, such as by combining with the crystallized debranched starch and xanthan gum.

A hydrocolloid, such as corn syrup solids, can be included in the composition. Though not to be bound by theory, if a hydrocolloid is included, a gel forms via interaction of the starch particles with themselves and the hydrocolloid, which forms colloids or polymers depending on their level of hydration and entanglement. These materials are held together via hydrogen bonding and polymer entanglement. Two physical parameters control the formation of a gel: interaction energy and volume fraction. The formation of a gel only occurs when these two attributes are properly balanced. If the interaction energy is too high, a hard, inflexible fibrous network forms. Likewise if the interaction energy is too low, the material can re-arrange to easily and behaves as a liquid. This liquid like behavior is also manifested in systems with a low volume fraction of solids. The solid particles are too dilute to interact and form a gel. However, if the volume fraction of solids is too high, the material becomes jammed and immobile, resulting in more solid behavior.

Both the interaction energy and volume fraction can be independently varied and controlled experimentally to induce gel formation. Experimental control of the volume fraction is straightforward-experimental materials can be diluted with a solvent or concentrated to change the volume fraction. However, the interaction energy is much more difficult to manage in an experimental system. Typically the Boltzmann energy (k_{B}T) is used to quantify interaction energy, and thus the interaction energy varies with temperature in the expected way. The much more difficult point to address is the nature of the interactions. Binary polymer-polymer, polymer-colloid, or colloid-colloid interactions all play an important role, and depend upon the identities of the species of interaction. Tertiary and higher order interactions may also need to be taken into account. Thus the successful synthesis of a gel requires understanding and management of the interaction energies involved.

As stated above, the composition is suitable for use as a fat replacer. In one embodiment, the present invention relates to a food formulation, comprising:

a foodstuff, and

the composition as described above.

Any foodstuff, from which it is desired to prepare a food formulation having reduced fat, can be used in the food formulation. In one embodiment, the foodstuff is selected from the group consisting of soups, sauces, dressings, fillings, and gravies.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

Preparation of Enzyme Modified Dent Starch

Into a vessel was added 250 lb of regular dent corn starch and 1420 lb water to give 15% starch slurry. The starch slurry was jet cooked at approximately 149° C. at a feed rate of approximately 2.0 gpm and the resulting paste was flashed into a tank and maintained at approximately 88° C., with agitation.

Into the dent corn starch paste as it entered the tank, was injected a total of approximately 8,000 GTU/lb starch of 4-α-glucanotransferase enzyme spread over the entire time period the paste was pumped into the tank. The mixture was allowed to react 3 hr at 88° C. with agitation.

Dilute sulfuric acid was added to adjust the pH to 3.8-3.9 and the reactor contents were cooled rapidly to approximately 55° C. by pumping through a heat exchanger into an agitated tank maintained at 55° C. To the slurry was added 0.1 ml/100 g of starch of isoamylase enzyme obtained from Haishibara Co. and the enzyme was allowed to react 16 hr. at 55° C. while maintaining the pH at 3.8-3.9.

The slurry was then jet cooked at approximately 149° C. and allowed to cool slowly with stirring to 55° C. then held at 55° C. overnight to promote crystal formation. The slurry was then dewatered on a basket centrifuge and dried overnight in a tray dryer to approximately 10% moisture content. The enzyme modified starch product was ground to pass through a US #40 mesh sieve and labeled.

Preparation of Fat-Replacer from Enzyme Modified Dent Starch

To 200 g enzyme modified starch above was added 600 g water and the slurry was heated to 60° C. 200 g of 1.25% xanthan gum solution was added. The slurry was loaded into a microfluidizer (Model 110Y, Microfluidics) and sheared at 10,000 psig. After 3 passes thru the microfluidizer the sample was collected and cooled overnight in the refrigerator

Yield stress and strain-sweep behavior of the creams were measured using a Brookfield vein method and TX Rheometer, respectively.

At 20% dry solids a yield stress of >400 Pa was found for the samples. The samples also showed a short texture as measured by strain-sweep analysis.

### Example 2

Preparation of Instant Fat-Replacer

8.5 grams of xanthan gum (GRINDSTED®Xanthan EASY, Danisco A/S, Grindsted, Denmark) was dissolved in 671.5 grams deionized water, heating to 60° C. Once the solution was homogenously mixed it was refrigerated overnight. Another liquid mixture was prepared consisting of 13.6 grams of sodium dodecyl sulfate in 1972 grams of deionized water and 748 grams of enzyme modified dent starch prepared as described in Example 1. Both mixtures were heated to 60° C. and stirred for 15 minutes. The mixtures were then combined and again stirred for 15 minutes. The combined mixture was then processed through a Microfluidics microfluidizer. Three passes were made at ˜10,000 psi and a solid plastic cream formed. The resulting cream was then spray dried, giving a fine, dry powder product. The dry powder was then reconstituted at 20% dry solids in deionized water. The solution was maintained at room temperature and stirred with a magnetic stirrer at 600 rpm for 10 minutes.

### Example 3

Preparation and Testing of Starch-Based Fat-Mimetic Creams

Starch

Enzyme-modified starch was provided by Tate & Lyle, Decatur, Ill. Dent starch was treated with glucanotransferase enzyme and fully debranched with isoamylase. The debranched material was crystallized, centrifuged, dried, and ground to pass through a #40 mesh sieve. No heat moisture treatment was applied to the crystallized samples.

Gum Solutions

Xanthan gum (GRINDSTED®Xanthan EASY, Danisco A/S, Grindsted, Denmark) was mixed with water to give dispersions of 1.0%, 1.25%, 1.5%, and 2.0% on a weight/weight basis. The xanthan gum mixtures were stirred at room temperature for at least 3-4 hours and stored at about 4° C. prior to use. All other gum solutions were prepared in a similar way. Sodium benzoate (1% w/w) was added to all gum solutions for microbial stability of both the gums and the final fat-mimetic creams.

Rheology

Rheological methods used for the evaluation of fat-mimetic creams include dynamic rheological test (e.g., strain sweep analysis) with a rheometer and yield stress measurement with a 5XHBTD Brookfield viscometer equipped with vane tool. The rheological behavior of different fat-mimetic creams was measured by determining the yield stress and recording the strain-sweep curves. Stellar (Tate & Lyle), a fat-mimetic cream comprising unmodified starch and containing no enzyme-modified starch, prepared by an instant process (reconstitution of dry powder in water), provided comparative examples.

| | | Dry solids | Strain- | Yield Stress |
|---|---|---|---|---|
| Sample | Process | (%) | Sweep | (Pa) |
| EMS-based | described above | 15 | 9.3 | 159 |
| EMS-based | described above | 20 | 19.7 | 337 |
| Stellar | Instant | 15 | 6.2 | 106 |
| Stellar | Instant | 20 | 17.7 | 303 |

EMS, enzyme-modified starch.

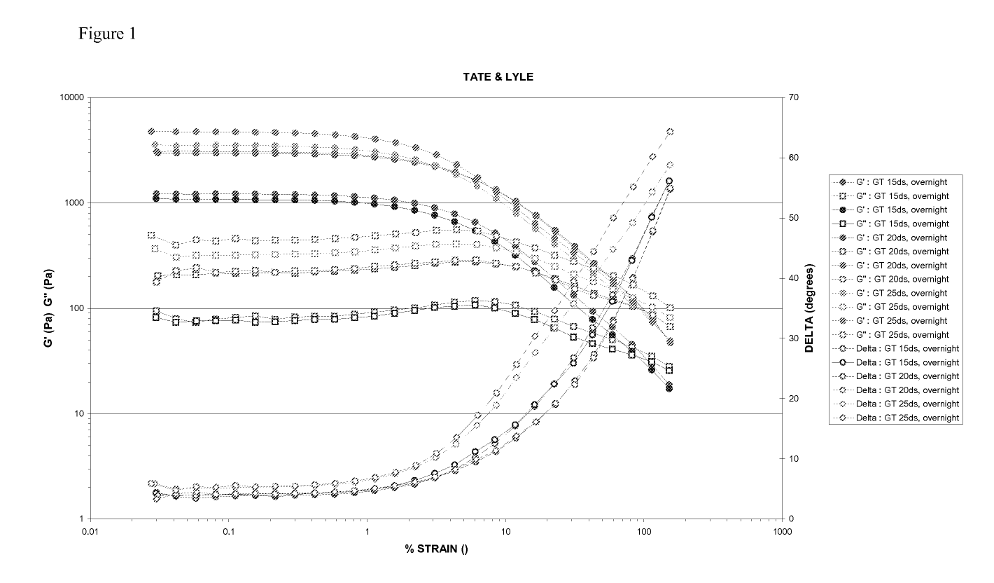

In addition, FIG. 1 shows the yield stress versus strain of several cream samples of 15%, 20% and 25% ds were prepared with either instant Stellar or the EMS-based cream described above. FIG. 1 shows the viscoelastic nature of the EMS-based creams. The EMS-based cream showed the highest G′ and G″ profiles at 20% ds.

Also, each sample was tested twice on a TA 2000 rheometer and obtained fairly good reproducibility. The following table shows the G′ or elastic-modulus, yield strain (critical strain at which the sample displays non-linear rheology) and yield stress (measured by Brookfield).

| TA Rheometer Data | | | | | | Brookfield |
|---|---|---|---|---|---|---|
| | | G′ 1 | G′ 2 | G′ Avg | Yield Stain | Yield Stress |
| Sample | DS | (Pa) | (Pa) | (Pa) | (%) | (Pa) |
| GT | 15 | 1201 | 1067 | 1134 | 0.81 | 159 |
| GT | 20 | 2917 | 3008 | 2963 | 0.81 | 337 |
| GT | 25 | 3470 | 4653 | 4061 | 0.82 | 250 |
| Stellar | 15 | 51 | 54 | 52 | 1.56 | 106 |
| Stellar | 20 | 2031 | 1831 | 1931 | 1.56 | 303 |
| Stellar | 25 | 10955 | 9537 | 10261 | 1.56 | 1487 |

Spray-Drying

If necessary, sheared samples were diluted prior to spray-drying to assure that the spray-dryer pump would be able to pump the sample. Samples were spray-dried using a lab spray-drier (LabPlant) with different settings of speed and inlet temperature. The dried samples were collected in plastic sample bags. Inlet temperatures of 155° C., 160° C., and 170° C. were used with speed settings of 6 and 15, giving outlet temperatures of 75-100° C.

An enzyme-modified starch composition was sheared at 15% ds with a microfluidizer. Microfluidizer conditions: Inlet Temperature=60° C., Pressure=10,000 psig, Passes=3. After shearing, the samples were diluted to 10% ds prior to spray-drying. The spray-drying conditions tested were as follows:

Inlet T=170° C., Outlet T=100° C., Speed=6

Inlet T=170° C., Outlet T=84° C. Speed=15

Inlet T=155° C., Outlet T=90° C., Speed=6

Shearing

Samples were mixed with water and xanthan gum solutions to give slurries with the desired dry solids (% d.s.) and xanthan gum levels. The starch was first mixed with water and stirred for ˜10 min before addition of the xanthan gum solutions. The starch/xanthan slurries were mixed for at least 1 hr prior to shearing. The slurries were equilibrated at a certain temperature in a water bath and subsequently sheared using a Microfluidizer (Model 110Y, Microfluidics Co.).

Samples were sheared at different temperatures, d.s. levels and pressures. All samples sheared at elevated temperatures and ˜10,000 psig formed good creams after 2-3 passes. Samples sheared at room temperature formed weak creams.

Sheared samples were collected and allowed to cool overnight in the refrigerator prior to any analysis. Samples were sheared at 10%, 15%, and 20% d.s. at room temperature and 50° C. The number of passes thru the Microfluidizer tested was 1-5. Xanthan gum levels of 1.0%, 1.25%, 1.5%, 2.0%, and 5.0% on a dry starch basis were tested.

Enzyme-modified starch samples that were sheared with the Microfluidizer at 20% d.s. gave good creams with high yield stress and short texture. The yield stress and texture of the EMS-based creams was better than for Instant Stellar samples that were analyzed for comparison.

A compressor was rented to test the effect of higher shearing pressures on the performance of enzyme-modified starch samples. An enzyme-modified starch sample was sheared at 10,000 psig or 17,000 psig at 20% ds. The resulting EMS-based creams were analyzed for yield stress. The sample sheared at the higher pressure had a 3× higher yield stress than the sample sheared at the lower pressure. Sample at 10,000 psig=300 Pa Yield Stress. Sample at 17,000 psig=950 Pa Yield Stress.

### Example 4

In a second shearing trial, a DeBEE 2000 Pilot Homogenizer (BEE International, Inc., South Easton, Mass.) was used. This homogenizer allows the use of different reaction chamber configuration as well as counter-flow. In the counter-flow configuration, two sheared product streams hit each other at high pressure. This configuration gave superior creams at all pressure and reactor settings.

Only one pass through the homogenizer at high pressure (˜10,000 psig) and counter-flow was necessary to give good creams compared to 2-3 passes on the Microfluidizer.

Samples were sheared using different combinations of reaction chambers and pressure. All samples were tested with the gum added either before or after the high pressure shearing

Samples:

Enzyme-modified starch with 1.5% xanthan gum

Enzyme-modified starch with 3.0% xanthan gum

Enzyme-modified starch with 10% alginate

Enzyme-modified starch with 1.5% carboxymethylcellulose

Conditions Tested:

Enzyme-Modified Starch

20% d.s., 1.5% xanthan gum

45,000 psig, 1 pass, 11 reactors

Enzyme-Modified Starch

18% d.s., 1.5% xanthan gum added after shearing

45,000 psig, 1 pass, 11 reactors

Enzyme-Modified Starch

20% d.s., 3.0% xanthan gum added after shearing

45,000 psig, 1 pass, 11 reactors

Enzyme-Modified Starch

16.7% d.s., 3.0% xanthan gum added after shearing

45,000 psig, 1 pass, 11 reactors

Enzyme-Modified Starch

20% d.s., 10% alginate

45,000 psig, 1 pass, 11 reactors

Enzyme-Modified Starch

16.7% d.s., 10% alginate

45,000 psig, 1 pass, 11 reactors

Enzyme-Modified Starch

20% d.s., 1.6% carboxymethylcellulose

45,000 psig, 1 pass, 11 reactors

Enzyme-Modified Starch

18.4% d.s., 1.6% carboxymethylcellulose

45,000 psig, 1 pass, 11 reactors

Sheared samples were spray-dried in the lab and tested to see if they were instant, i.e. re-formed a cream when low shear (500 rpm) was applied for 10 min. None of the tested samples were instant.

All samples were strong creams before spray-drying, but lost their structure upon drying. The strength of the creams before drying and microscopy pictures of some creams suggest a sufficiently small particle size.

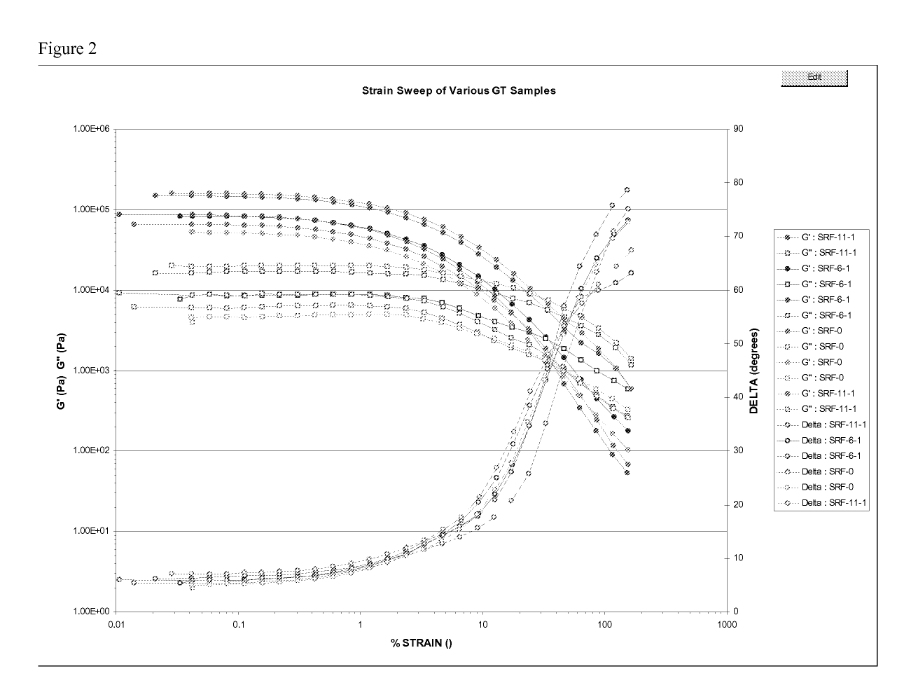

No difference was seen between the gums tested in this trial. Addition of the gums before or after high pressure shearing gave the same results and the level of gum added did not seem to affect the cream rheology (FIG. 2).

The creams were submitted for rheology analysis, but were too thick for analysis indicating yield stress values>>1000 Pa.

| | | | Brookfield | |
|---|---|---|---|---|
| Samples | process | ds | (5XHBTD) Reading | Yield Stress (Pa) |
| Enzyme- | described | 20 | 47.2 | 808.536 |
| modified | above | | | |
| starch | | | | |
| Enzyme- | SRF-11-1 | 20 | over limit | >>1000 |
| modified | | | | |
| starch | | | | |
| Enzyme- | SRF-6-1 | 20 | over limit | >>1000 |
| modified | | | | |
| starch | | | | |

SRF—single reverse flow
11-1: 11 reactors, 1 pass
6-1: 6 reactors, 1 pass

### Example 5

Acid Hydrolysis of Enzyme-Modified Starch

Starting with an enzyme-modified starch slurry as described above, the effect of acid hydrolysis was examined. The following procedure was followed:

Prepared starch slurry at 34% d.s. and heated to 70° C. Added conc. HCL to give 37 ml acid for 1000 g slurry. Neutralized to pH 4-4.5 using 1.5N NaOH. Filtered and washed sample. Determined hydrolysis extent from dry solids and volume of filtrate and wash.

Results

After 1 hr, only 11% of the sample was hydrolyzed and only 16% was hydrolyzed after 5 hrs. Samples formed good creams after shearing with yield stress values similar to non-acid hydrolyzed creams.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and articles described herein without departing from the concept, spirit and scope of the invention. More specifically, it will be apparent that certain agents may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A composition, comprising:
a starch comprising short chain amylose having an average degree of polymerization (DP) from about 20 to about 150, wherein an aqueous slurry comprising about 20% d.s.b. of the composition has a minimum yield stress of at least 400 Pa.

2. The composition of claim 1, wherein the starch is from dent corn, waxy corn, high amylose corn, potato, tapioca, rice, pea, wheat, waxy wheat, or a combination of two or more thereof.

3. The composition of claim 1, comprising greater than about 95% d.s.b. starch.

4. The composition of claim 1, prepared by a process comprising:
contacting a starch paste with a 4-α-glucanotransferase, to yield a chain-extended starch;
contacting the chain-extended starch with a debranching enzyme, to yield a debranched starch;
crystallizing the debranched starch, to yield a crystallized debranched starch; and
shearing the crystallized debranched starch, to yield the composition.

5. The composition of claim 1, further comprising from about 0.5% d.s.b. to about 2% d.s.b. of xanthan gum.

6. The composition of claim 5, wherein the process further comprises combining the crystallized debranched starch with xanthan gum, to yield a mixture comprising starch and xanthan gum; and wherein shearing comprises shearing the mixture comprising starch and xanthan gum.

7. A method of preparing a composition comprising starch comprising short chain amylose having an average degree of polymerization (DP) from about 20 to about 150, wherein an aqueous slurry comprising about 20% d.s.b. of the composition has a minimum yield stress of at least 400 Pa, the method comprising:
contacting a starch paste with a 4-α-glucanotransferase, to yield a chain-extended starch;
contacting the chain-extended starch with a debranching enzyme, to yield a debranched starch;
crystallizing the debranched starch, to yield a crystallized debranched starch; and
shearing the crystallized debranched starch, to yield the composition.

8. The method of claim 7, further comprising combining the crystallized debranched starch with xanthan gum, to yield a mixture comprising starch and xanthan gum; and wherein shearing comprises shearing the mixture comprising starch and xanthan gum, to yield the composition.

9. The method of claim 7, wherein the starch paste is contacted with 4-α-glucanotransferase at a temperature from about 70° C. to about 100° C. and a pH from about 5.0 to about 6.0.

10. The method of claim 9, wherein the 4-α-glucanotransferase is used in a dosage from about 2500 GTU/lb of starch to about 20,000 GTU/lb of starch.

11. The method of claim 7, wherein the chain-extended starch is contacted with debranching enzyme at a temperature from about 40° C. to about 70° C. and a pH from about 3.5 to about 4.5.

12. The method of claim 11, wherein the debranching enzyme is used in a dosage from about 150,000 U/kg of starch to about 15,000,000 U/kg of starch.

13. The method of claim 7, wherein crystallizing comprises cooking the debranched starch at a temperature from about 120° C. to about 180° C. and cooling the cooked debranched starch to a temperature from about 40° C. to about 70° C.

14. A food formulation, comprising:
a foodstuff, and
a composition comprising a starch comprising short chain amylose having an average degree of polymerization (DP) from about 20 to about 150, wherein an aqueous slurry comprising about 20% d.s.b. of the composition has a minimum yield stress of at least 400 Pa.

15. The food formulation of claim 14, wherein the foodstuff is selected from the group consisting of soups, sauces, dressings, fillings, and gravies.
